(19) United States
(12) Patent Application Publication
(10) Pub. No.: US 2009/0113476 A1
(43) Pub. Date: Apr. 30, 2009

(54) ELECTRONIC CATALOG SYSTEM

(76) Inventor: Peter Samuel Vogel, Faulconbridge (AU)

Correspondence Address: Peter Samuel Vogel, 30 Adeline Street, Faulconbridge, 2776, AU

(21) Appl. No.: 12/255,618

(22) Filed: Oct. 21, 2008

(30) Foreign Application Priority Data
Oct. 24, 2007 (AU) 2007905793

(51) Int. Cl. H04N 5/445; H04N 7/173

(52) U.S. Cl. 725/39; 725/131

(57) ABSTRACT

A set-top-box receives catalogs through digital TV data broadcast or through the Internet. The catalogs are stored as files on the STB e.g. on hard drive or solid state memory. Usually, a particular user will receive only a subset of transmitted catalogs according to preferences set or deduced from user-specific information such as location. Users can search the catalogs by store, category keyword or other terms. Catalogs can appear in the “channels” menu or the “library” menu or any other menu. The ordering of catalogs displayed in a menu can be arranged according to likely interest to a viewer, or with “specials” first, or “newest” first or “closest” first etc. Viewers can click straight to a catalog or item when invited during watching a show or a commercial. They can be notified of specials, new catalogs or new items by means of an icon or other popup, or a notice appearing on a menu, or by SMS or email etc.

### FIELD OF THE INVENTION

The present invention relates to systems for delivering catalogs and similar advertising materials to the home through the medium of the household television set.

### BACKGROUND OF THE INVENTION

Home-delivered catalogs are a very popular and successful method of advertising goods and services. However the monetary and environmental cost of producing, distribution and disposing of physical catalogs is significant. A growing number of householders are objecting to so-called junk mail, and many are refusing to allow such deliveries.

Some advertisers are now utilizing websites as an alternative method of catalog delivery and while this has many benefits over physical distribution, the consumer must use the Internet and a computer to access the catalogs. Many homes do not have Internet and computers. Another limitation is that the user requires special skills to find and access catalogs in this way.

### SUMMARY OF THE INVENTION

It is an object of this invention to reduce the cost and environmental damage of catalog advertising by providing a system and process of electronic delivery of catalogs to the home.

It is a further object to provide a system which delivers catalogs in the home's most frequented area, such as the living room. It is another object to present catalogs with minimal effort by the householder.

In one aspect, the present invention provides a catalog delivery method comprising the steps of receiving a catalog in the form of electronic data; storing said data within a domestic television appliance which also receives a plurality of television programs; and, responsive to selection commands from a viewer, displaying one of said programs or one of said catalogs on a television display device.

In some embodiments, the step of receiving a catalog comprises the sub-step of receiving data representing a catalog in digital form embedded within a digital television broadcast. In other embodiments, the step of receiving a catalog comprises the sub-step of receiving data representing a catalog in digital form from a source separate from a digital television broadcast, such as the Internet. In yet other embodiments both television programs and catalog data are received from the Internet.

In another aspect, the present invention further provides a method of searching said stored catalogs according to criteria defined by the user.

According to an extension of the inventive concept, a plurality of catalogs are transmitted for reception by said television appliance and said appliance is adapted to selectively store only a subset of said transmitted catalogs. The selection criteria can include, for example, the geographic location of the appliance, the demographic profile of the householder, or household viewing patterns.

According to other extensions of the invention, multiple profiles are configured corresponding to different persons who may be using the invention in a particular household, so that selection criteria used for storing or displaying catalogs is optimized according to which person or persons are using the invention at that time.

In another aspect, the invention is further adapted to receive a command from a viewer watching a program and, responsive to the particular program content at that moment, suspend display of the program and commence display of a catalog. In this aspect, the invention provides a system for linking program content to advertisers' catalogs. In another extension, catalogs so accessed can be presented initially displaying a particular item predetermined by the advertiser as being related to the program content.

According to a further extension of the inventive concept, the invention further provides a system for linking catalogs to supplementary content such as websites, video commercials or programmes. For example, by clicking the appropriate button on a remote control the viewer can invoke playback of a recorded video file which presents a demonstration of the features of a product highlighted in the catalog being viewed at that time.

In another aspect, the invention further comprises the steps of receiving an alert signal and displaying an alert symbol on said television display device. Said alert signal indicates that a catalog or a catalog item that is likely to be of interest to a particular viewer is available. In some embodiments said alert is generated spontaneously by logic means making a determination based on certain characteristics of the viewer including for example location or viewing habits. In other embodiments said alerts are generated in response to an expression of interest established by the viewer. For example the viewer may request alerts be sent whenever a discount is offered on toilet paper at a store within 10 km.

In another aspect, the invention further comprises the step of displaying the names of catalogs received and stored according to the inventive process. In some embodiments, the names of catalogs appear in the “channels” menu of a television appliance, in other embodiments they appear in the “library” or other menu. The ordering of catalogs displayed in a menu can be arranged in many ways, for example according to likely interest to a viewer, with “specials” first, “newest” first or “closest” first.

The invention also consists in apparatus adapted to perform the steps of the invention described herein.

### DESCRIPTION OF PREFERRED EMBODIMENTS

Embodiments of the invention will now be described with reference to the drawings in which:

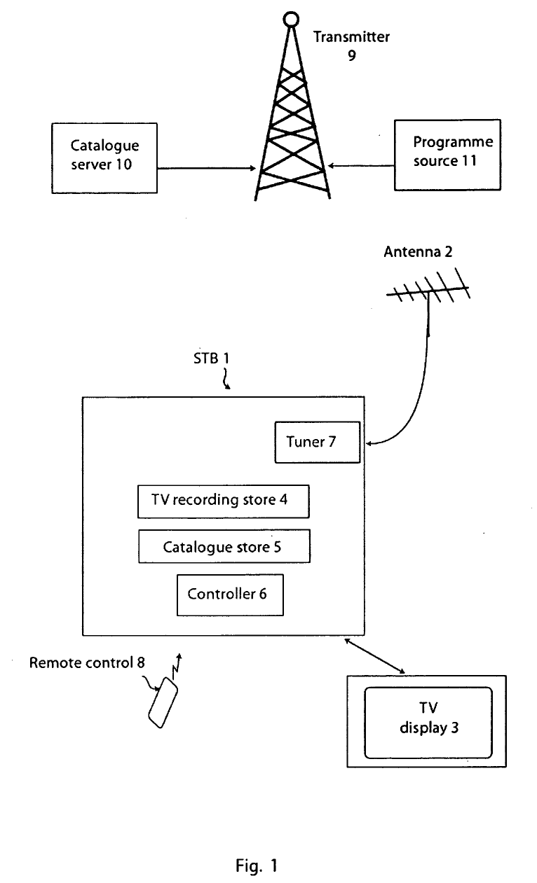

FIG. 1 is a block diagram of an embodiment of the present invention in which catalogs are delivered as part of a digital television transport stream; and

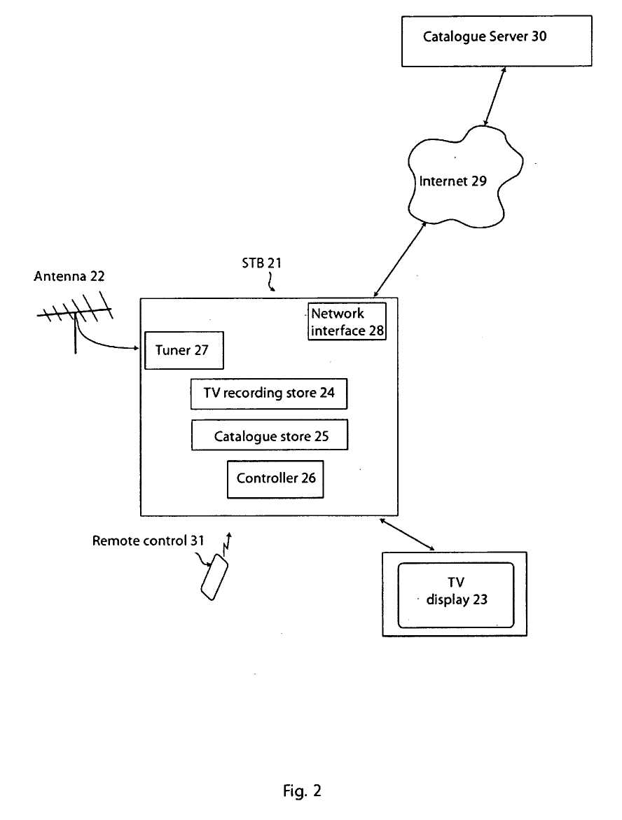

FIG. 2 is a block diagram of an embodiment of the present invention in which catalogs are delivered through the Internet.

Referring now to FIG. 1, STB (set-top-box) 1 is an integrated receiver/decoder suitable for digital terrestrial television reception. Transmitter 9 is a television broadcasting station which broadcasts television programmes from programme source 11. Controller 6 within STB receives television broadcast signals via antenna 2 and tuner 7. These signals comprise a digital transport stream which controller 6 decodes as required to provide video and audio output which can be displayed by TV display 3 for immediate viewing or saved on TV recording store 4 for viewing at a later time.

The transport stream received by tuner 7 also periodically includes data packets describing advertising catalogs. These originate from catalog server 10 and are transmitted by transmitter 9. Controller 6 recognises these packets and stores the corresponding data in catalog store 5. TV recording store 4 and catalog store 5 are typically a hard disk drive, or in cases where very little or no television programme storage is required, semiconductor memory can be used instead.

In the case where no hard drive is used, it is desirable to minimise the amount of data stored in catalog store 5 as it is prohibitively expensive to provide large amounts of semiconductor storage. Accordingly, to reduce the amount of storage required, the invention is adapted to store only a subset of all catalogs broadcast. For this purpose, controller 6 is adapted to filter received catalog data according to certain criteria and store only those matching certain criteria. For example, many catalogs are applicable to certain geographical areas and hence of little interest to people outside those areas. Accordingly, catalog data used by this invention contains metadata which assists with this filtering and targeting. In the example of geographic targeting, the metadata includes information about the area applicable, and controller 6 compares this to location information entered by the user, such as postcode. Targeting can be based on many factors, such as the viewer's interests, age, sex, family situation income etc.

In some embodiments, filtering of received catalogs can be determined by the user's viewing habits. For example, if the viewer frequently watches or records children's programs, catalogs containing toys and children's clothing will be stored preferentially. In other cases, time of peak viewing can be used as an indicator of the household composition. For example if most television viewing occurs between 8 pm and midnight, adult viewers are assumed and catalog selection is filtered accordingly.

In this embodiment, controller 6 is adapted to place a visible icon in the corner of the picture displayed on TV display 3 when a new catalog is received and storage is completed. A short message such as “KMart Winter catalog ready” might also be displayed. The icon and/or message are cleared by pressing the appropriate button on remote control 8, or might be automatically cleared after a certain time.

Pressing the appropriate sequence of buttons on remote control 8 causes a menu of catalogs to be displayed, from where the user can select a catalog of interest to be opened. Catalogs can conveniently be stored in well-known standard formats such as HTML or Adobe Flash files and suitable software is provided to allow access by searching or browsing.

In the preferred embodiment, the menu of catalogs is ordered so that those which are potentially the most interesting will be displayed most prominently, for example at the top of a list.

The viewer uses a remote control to initiate a variety of searches. One search option is by keyword. For example the remote control is used to enter text using the well-known keyboard techniques of SMS messaging which utilises the digits 0-9 for alphabetic entry. The text entered is used to locate matching catalog entries. Other searches find catalogs of particular stores, or stores servicing a particular area.

A useful extension of this embodiment of the invention is to include predictive text capability so that the when the user enters the first letters of a search term, the invention automatically completes the text entry field with a predicted value based on a stored dictionary. A further extension can be provided whereby the dictionary used for prediction is constructed or augmented from the text content of catalogs stored by the invention.

In some embodiments of the invention, catalogs are listed in a menu reserved for the purpose. In other embodiments, the catalogs are listed as part of the listing of television channels available for viewing. In yet other embodiments, the catalogs are listed within the listing of recorded programs available for viewing.

Referring now to FIG. 2, an embodiment of the invention will be described in which the catalog data is delivered via the Internet.

This embodiment of the invention is the same as that of FIG. 1 except that it further includes network interface 28 which connects STB 21 to Internet 29 and catalog server 30 which is connected to the Internet.

In this embodiment, the catalog data is delivered through the Internet rather than as part of the television broadcast signal.

The targeting of catalogs received and stored can be achieved by catalog server 30 which selectively serves catalogs according to demographic data sent from the requesting viewers' STB. Alternatively, catalog server 30 can include a database of users which contains demographic information on which it draws to determine which catalog to serve to each user.

Antenna 22, tuner 27, TV recording store 24, catalog store 25, controller 26 and TV display 23 otherwise operate in the same manner as described in relation to the embodiment of FIG. 1.

It will be understood that many other embodiments are possible without departing from the scope of the present invention.

Whereas the invention described above includes a system for displaying a visible indicator or icon to notify users of special offers, notification of new catalogs or new items by other means is also anticipated, for example by means of a popup message, a notice appearing on a menu, or by SMS or email.

While the preferred embodiments described herein describe implementation of the invention in a television set-top-box, the invention can also be incorporated into other devices, for example a television set, handheld television, DVD recorder, or a personal computer adapted to receive television programmes.

It is further anticipated that in some embodiments catalog data will be stored in the television appliance, such as a digital STB, but in other embodiments it may be preferable to store the data externally to the appliance, for example a different device such as a personal computer within the home, a removable memory device, or a server remote from the home connected via a data network. Similarly, the searching or retrieving steps of the inventive concept can be executed locally to the television appliance or remotely by another suitably-equipped device.

Although the preferred embodiments of the invention described herein include storage means for recording and replaying broadcast television programmes, this is not an essential characteristic of the invention. The invention can be effectively utilised in conjunction with live TV viewing in which case storage of programme material is not required.

Whereas the embodiments of the invention described above refer to delivery of catalogs, the invention can equally well be applied to delivery of other visual or text communications. For example, the invention can be used to electronically deliver newsletters, newspapers, magazine, bills, notices or any other items of potential interest to a householder. The material delivered can also be multi-media, for example including sound or static or moving images. Interactivity can be added to allow, for example, immediate paying of bills.

It is also envisaged that the invention can include other accessories such as a printer for selective production of hard copy, either on demand or automatically.

1. A television receiving system comprising means for receiving and displaying television program signals, means for receiving page description data representative of print format documents, means for storing said page description data, and means for selectively retrieving and displaying said stored information data.

2. A television receiving system according to claim 1 and further comprising filtering means adapted to cause only a subset of received page description data to be stored.

3. A television receiving system according to claim 2 wherein said filtering means is adapted to filter page description data according to probability that said data will be of interest to the user of the invention.

4. A television receiving system according to claim 1 wherein said page description data is embedded within a television broadcast.

5. A television receiving system according to claim 1 wherein said page description data is received from a source separate from a television broadcast.

6. A television receiving system according to claim 1 further comprising means for searching said page description data according to criteria defined by the user.

7. A television receiving system according to claim 1 further comprising means to receive a command from a viewer watching a program and, responsive to the particular program content at that moment, suspend display of the program and commence display of a page constructed from said stored page description data.

8. A television receiving system according to claim 1 wherein pages displayed using said stored page description data include links to supplementary content.

9. A television receiving system according to claim 1 further comprising means to display an alert symbol on said television display device when a page description representing an item that is likely to be of interest to the particular viewer has been received.

10. A television receiving system according to claim 9 wherein said alert is generated spontaneously by logic means making a determination based on characteristics of the viewer.

11. A television receiving system according to claim 9 wherein said alert is generated in response to an expression of interest established by the viewer.

12. A television receiving system according to claim 1 wherein said page description data is stored as multiple discrete documents each having a designated name.

13. A television receiving system according to claim 12 wherein said designated names appear in a menu of the user interface of said television receiving system.

14. A television receiving system according to claim 13 wherein the ordering of document names displayed in a menu is selected from the group consisting of: most likely to be of interest to the viewer first, specials first, newest first or closest first.

15. An electronic document delivery method comprising the steps of receiving and displaying television program signals, receiving page description data representative of print format documents, storing said page description data, and selectively retrieving and displaying said stored information data.

16. An electronic document delivery method according to claim 15 further comprising the step of filtering so that only a subset of received page description data is stored.

17. An electronic document delivery method according to claim 16 wherein said filtering step filters page description data according to probability that said data will be of interest to the user of the invention.

18. An electronic document delivery method according to claim 15 wherein said page description data is embedded within a television broadcast.

19. An electronic document delivery method according to claim 15 wherein said page description data is received from a source separate from a television broadcast.

20. An electronic document delivery method according to claim 15 further comprising the steps of receiving search criteria from the user and searching said page description data according to said received criteria.

21. An electronic document delivery method according to claim 15 further comprising the steps of receiving a command from a viewer and, responsive to the particular program content at that moment, suspending display of the program and commencing display of a page constructed from said stored page description data.

22. An electronic document delivery method according to claim 15 wherein pages displayed using said stored page description data include links to supplementary content.

23. An electronic document delivery method according to claim 15 further comprising the step of displaying an alert symbol on said television display device when a page description representing an item that is likely to be of interest to the particular viewer has been received.

24. An electronic document delivery method according to claim 23 wherein said alert is generated spontaneously by logic means making a determination based on characteristics of the viewer.

25. An electronic document delivery method according to claim 23 wherein said alert is generated in response to an expression of interest established by the viewer.

26. An electronic document delivery method according to claim 15 wherein said page description data is stored as multiple discrete documents each having a designated name.

27. An electronic document delivery method according to claim 26 and further comprising the step of displaying said designated names in a menu of the user interface of said television receiving system.

28. An electronic document delivery method according to claim 27 wherein the ordering of document names displayed in a menu is selected from the group consisting of: most likely to be of interest to the viewer first, specials first, newest first or closest first.
